(19) United States
(12) Patent Application Publication
(10) Pub. No.: US 2003/0080930 A1
(43) Pub. Date: May 1, 2003

(54) LCD device for showing multiple pictures

(75) Inventor: Huang-Tsun Chen, Taipei (TW)

Correspondence Address: BACON & THOMAS, PLLC, 625 SLATERS LANE, FOURTH FLOOR, ALEXANDRIA, VA, 22314

(73) Assignee: AIPTEK International Inc., Hsinchu (TW)

(21) Appl. No.: 09/984,754

(22) Filed: Oct. 31, 2001

(51) Int. Cl. G09G 3/36

(52) U.S. Cl. 345/87

(57) ABSTRACT

An liquid crystal display (LCD) device comprises: a control circuit for providing video signals of a plurality of pictures in sequence; a voltage-level shift circuit for shifting and applying different voltage levels on crystal molecules in the LCD device to twist them to different orientations in order to create different rotary polarization effects; and a light-guiding filter layer for filtering and scattering light in different orientations to make it possible for viewing pictures from various angles. The light-guiding filter layer may be placed in front of or behind a color-filter layer or combined with the latter to form a unitary layer.

### FIELD OF THE INVENTION

This invention relates generally to a liquid crystal display (LCD), particularly to LCD device for showing multiple pictures.

### BACKGROUND OF THE INVENTION

As shown in FIG. 1, a conventional liquid crystal display (LCD) device 10 usually comprises at least a color filter layer 11, a liquid crystal layer 13, a vitreous substrate 15, and a deflection layer 17. When a voltage is applied to the liquid crystal layer 13, the crystal molecules therein are forced to twist an angle to display different transparent degrees of an incident ray 100 and have an image emerged.

However, the conventional LCD device 10 can only show a monotonous picture only, it fails to show a plurality of video pictures synchronously, therefore, a user has to purchase some more LCD devices when viewing multiple pictures simultaneously is desired.

### SUMMARY OF THE INVENTION

The primary object of this invention is to provide a LCD device for showing multiple pictures synchronously.

In order to realize said object, the LCD device of this invention comprises: a control circuit for providing video signals of a plurality of pictures in sequence; a voltage-level shift circuit for shifting and applying different voltage levels on crystal molecules in the LCD device to twist them to different orientations in order to create different rotary polarization effects; and a light-guiding filter layer for filtering and scattering light in different angles to make it possible for viewing pictures from various orientations.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention to be made later are described briefly as follows, in which:

FIG. 1 shows the structure of a conventional LCD device; and

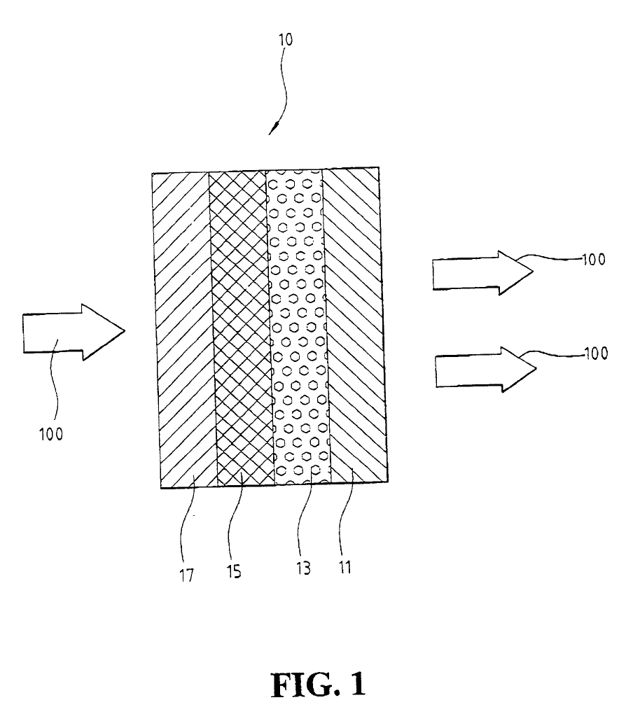

FIG. 2 shows the structure of a LCD device of this invention.

### DETAILED DESCRIPTION OF THE INVENTION

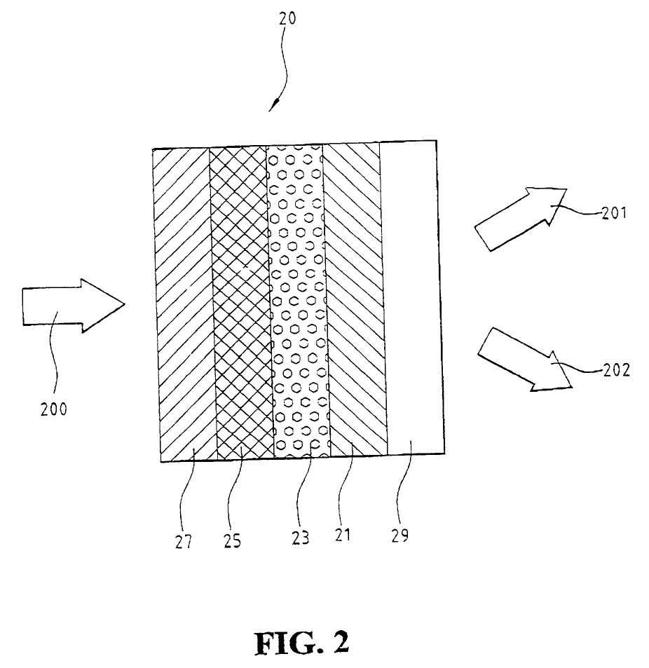

As illustrated in FIG. 2, a LCD device 20 of this invention comprises at least: a color filter layer 21, a liquid crystal layer 23, a vitreous substrate 25, a deflection layer 27, and a light-guiding filter layer 29. When a voltage is applied on the liquid crystal layer 23, the inside crystal molecules of the layer are twisted to have different transparent degrees of an incident ray 200 created and images emerged.

This invention is characterized in comprising: a control circuit for providing video signals of a plurality of pictures in sequence; a voltage-level shift circuit for shifting and applying different voltage levels on crystal molecules in the LCD device and twist them to different orientations in order to create different rotary polarization effects of an incident ray; and a light-guiding filter layer for filtering and scattering light in different orientations 201, 202 to make it possible for viewing pictures from various angles, wherein the light-guiding filter layer may be placed in front of or behind a color-filter layer or combined with the latter to form a unitary layer.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A liquid crystal display (LCD) device for showing multiple pictures, comprising:
a control circuit for providing video signals of a plurality of pictures in sequence;
a voltage-level shift circuit for shifting and applying different voltage levels on crystal molecules in the LCD device to twist them to different orientations in order to create different rotary polarization effects; and
a light-guiding filter layer for filtering and scattering light in different orientations to make it possible for viewing pictures from various angles.

2. The LCD device according to claim 1, wherein the light-guiding filter layer may be placed in front of or behind a color-filter layer or combined with the latter to form a unitary layer.
